(19) United States
(12) Patent Application Publication
(10) Pub. No.: US 2025/0373080 A1
(43) Pub. Date: Dec. 4, 2025

(54) WIRELESS POWER TRANSFER FOR BATTERY-ELECTRIC LOCOMOTIVES AND OTHER BATTERY-ELECTRIC VEHICLES

(71) Applicant: The University of North Carolina at Charlotte, Charlotte, NC (US)

(72) Inventors: Tiefu ZHAO, Charlotte, NC (US); Xiuhu SUN, Chapel Hill, NC (US); Xiwen XU, Santa Clara, CA (US); Shen-En CHEN, Charlotte, NC (US)

(21) Appl. No.: 19/224,334

(22) Filed: May 30, 2025

Related U.S. Application Data
(60) Provisional application No. 63/654,370, filed on May 31, 2024.
(60) Provisional application No. 63/654,357, filed on May 31, 2024.

(51) Int. Cl. H02J 50/10; H02J 50/40; H02J 50/90

(52) U.S. Cl. CPC H02J 50/10; H02J 50/402; H02J 50/90

(57) ABSTRACT

Predicting a DC output voltage of a WPT coupler includes dividing a length of transmitters into longitudinal misalignment distances, each associated with a distance between a receiver and a center of the transmitters, obtaining a coupling coefficient for each longitudinal misalignment distance and intermediate DC output voltages associated with each longitudinal misalignment distance and coupling coefficient, and summing the intermediate DC output voltages. An apparatus includes a transmitter frame, spaced apart W-shaped ferromagnetic cores, and a first conductive metal arranged in a first coil on a first plane on the W-shaped ferromagnetic cores. The apparatus includes a receiver frame, spaced apart I-shaped ferromagnetic cores, and a second conductive metal arranged in a second coil on a second plane on the I-shaped ferromagnetic cores. The receiver slidingly translates along a longitudinal axis shared with the transmitter and the first plane is separated from the second plane by an airgap.

### CROSS-REFERENCE TO RELATED APPLICATIONS

This application for patent claims priority to and the benefit of Provisional Patent Application No. 63/654,370 entitled Wireless Power Transfer for Battery-Electric Locomotives and Other Battery-Electric Vehicles, and Provisional Patent Application No. 63/654,357 entitled Magnetic Block Structures for Enhanced Coupling Coefficients In Wireless Power Transfer, both filed in the United States Patent and Trademark Office on May 31, 2024, the entire contents of each are incorporated herein by reference as if fully set forth below in their entireties and for all applicable purposes.

### STATEMENT OF GOVERNMENT SUPPORT

This invention was made with government support under 693JJ6-21-C-000002 awarded by The United States Department of Transportation. The government has certain rights in the invention.

### TECHNICAL FIELD

This disclosure relates generally to wireless power transfer, and more specifically, to wireless power transfer for battery-electric locomotives and other battery-electric vehicles.

### INTRODUCTION

Locomotives are used to transport goods and commodities produced and consumed in countries such as the United States. Locomotives, such as diesel-electric locomotives, transport such goods and commodities, for example, between cities, between ports, and between cities and ports. Diesel-electric locomotives are efficient in their use of diesel fuel when hauling great weights and volumes of goods and commodities over substantial distances, in comparison, for example, to the efficiency of diesel trucks transporting the same weights and volumes of goods and commodities over the same distances via highways and roads.

A desire to replace or augment national fleets of diesel-electric locomotives with battery-electric locomotives is gaining widespread favor. Battery-electric locomotives may be designed and manufactured to haul the same great weights and volumes of goods and commodities over the same great distances along existing rail lines. Some rail lines are electrified. For example, some rail lines already have catenary electric power cables overhead. Those electric power cables may be coupled to electric motors of a train via a pantograph system, which lifts a conductor above the train and holds the conductor in electrical contact with the overhead catenary electric power cables. However, not all rail lines have such overhead power cables. Furthermore, renovating all rail lines to include such overhead power cables may be unreasonably expensive, at least due to the cost of the many miles of continuous power cable and the hundreds of thousands of supports needed to hold the power cables over the rail lines.

Electric locomotives are widely used, but only 1% of locomotives in the United States are electrified. The high cost of electrifying railways (e.g., considering at least the cost of continuous lengths of power cables and pluralities of associated support structures) is a challenge, but an alternative approach involves retrofitting locomotives with batteries and chargers. Wired charging is hindered by complexity and weather limitations. Wireless Power Transfer (WPT) offers advantages by enabling charging during parking or motion, reducing charging time and battery pack size. A battery-electric locomotive may, for example, wirelessly obtain a charge for its batteries by passing over such charging zones (e.g., wireless charging of moving battery-electric locomotives) or by parking over such charging zones (e.g., wireless charging of stationary battery-electric locomotives). Scientists and engineers continue to perform research and development in association with improving the efficiencies of wireless power transfer for battery-electric locomotives and all types of battery-electric vehicles.

### BRIEF SUMMARY OF SOME EXAMPLES

The systems, methods, and devices of this disclosure each have several innovative aspects, no single one of which is solely responsible for the desirable attributes disclosed herein.

In one example, a method of predicting a direct current output voltage of a wireless power transfer (WPT) system coupler is described. The method includes dividing a predetermined length of a plurality of transmitters into a plurality of longitudinal misalignment distances, each of the plurality of longitudinal misalignment distances associated with a distance between a receiver element of the coupler and a center of the plurality of transmitters, obtaining a WPT system coupler coupling coefficient with respect to each of the plurality of longitudinal misalignment distances, obtaining a plurality of intermediate direct current output voltages associated with each of the plurality of longitudinal misalignment distances and the respective WPT system coupler coupling coefficients, and obtaining the direct current output voltage by summing the plurality of intermediate direct current output voltages.

In one example, an apparatus configured to predict a direct current output voltage of a wireless power transfer (WPT) system coupler is described. The apparatus includes one or more memories and one or more processors. The one or more processors are configured to, individually or collectively, based at least in part on information stored in the one or more memories: divide a predetermined length of a plurality of transmitters into a plurality of longitudinal misalignment distances, each of the plurality of longitudinal misalignment distances associated with a distance between a receiver element of the coupler and a center of the plurality of transmitters; obtain a WPT system coupler coupling coefficient with respect to each of the plurality of longitudinal misalignment distances; obtain a plurality of intermediate direct current output voltages associated with each of the plurality of longitudinal misalignment distances and the respective WPT system coupler coupling coefficients; and obtain the direct current output voltage by summing the plurality of intermediate direct current output voltages.

In one example, an apparatus is described. The apparatus includes one or more transmitters. Each transmitter includes a transmitter frame including a pair of spaced apart transmitter frame members, a plurality of spaced apart W-shaped ferromagnetic cores, each of the spaced apart W-shaped ferromagnetic cores located between the pair of spaced apart transmitter frame members and mechanically coupled to the pair of spaced apart transmitter frame members, and a first length of conductive metal arranged in a first coil on a first plane on the spaced apart W-shaped ferromagnetic cores, the first coil having a pair of transmitter electrodes. The apparatus also includes a receiver. The receiver includes: a receiver frame including a pair of spaced apart receiver frame members, a plurality of spaced apart I-shaped ferromagnetic cores, each of the spaced apart I-shaped ferromagnetic cores located between the pair of spaced apart receiver frame members and mechanically coupled to the pair of spaced apart receiver frame members, and a second length of conductive metal arranged in a second coil on a second plane on the spaced apart I-shaped ferromagnetic cores, the second coil having a pair of receiver electrodes. The receiver is configured to slidingly translate along a longitudinal axis (the X-axis) shared with the transmitter, in a spaced apart configuration in which the first plane of the transmitter is separated from the second plane of the receiver by a distance corresponding to an airgap.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an electrical schematic of a Wireless Power Transfer (WPT) system utilizing a dynamic LCL-s compensation topology according to some aspects of the disclosure.

FIG. 2A is a 3D rendering of a W-I shaped coupler with hanging bracket and tracks according to some aspects of the disclosure.

FIG. 2B is a graphic of the shapes of a transmitter (Tx) side W-shaped core and a receiver (Rx) side I-shaped core including additively constructed (shown as removed) features that can further reduce the weight of the receivers and transmitters fabricated according to some aspects of the disclosure.

FIG. 3A is a graphic illustration of the locations of a receiver of the WPT system utilizing the dynamic LCL-s compensation topology of FIG. 1 during a dynamic charging process according to some aspects of the disclosure.

FIG. 3B is a chart depicting a coupling coefficient of the W-I shaped coupler of the WPT system of FIG. 1 and FIGS. 2A and 2B during dynamic charging according to some aspects of the disclosure.

FIG. 4 is a photograph of a physical prototype of the dynamic WPT system of FIG. 1 and FIGS. 2A and 2B according to some aspects of the disclosure.

FIG. 5 presents multiple charts and a pictograph depicting a single-transmitter single-receiver (STSR) misalignment model experimental setup and results according to some aspects of the disclosure.

FIG. 6 is an efficiency map presenting regions of efficiency for various values of input voltage and load resistance according to some aspects of the disclosure.

FIG. 7 presents multiple experimental results for a three-transmitter single-receiver (TTSR) WPT system collected from a physical dynamic experimental setup according to some aspects of the disclosure.

FIG. 8 is a block diagram illustrating an example of a hardware implementation of a device employing one or more processing systems according to some aspects of the disclosure.

FIG. 9 is a flow chart illustrating an example process of predicting a direct current output voltage of a wireless power transfer (WPT) system coupler in accordance with some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. However, a person having ordinary skill in the art will readily recognize that the teachings herein can be applied in a multitude of different ways. Some or all of the examples described may be implemented in any device, system, or network that is capable of wireless power transfer according to one or more technologies or techniques. In some examples, wireless power transfer may involve, for example, the transmission and reception of radio frequency (RF) energy via antenna structures. One example of an antenna structure may include a coil of wire (e.g., a printed trace of metal shaped as a coil of one or more turns or a wire shaped as a coil of one or more turns). The described examples may be implemented, for example, across a broad range of technologies, such as but not limited to any type of battery-electric vehicles, such as but not limited to battery-electric locomotives, battery-electric tractor-trailers (e.g., big rigs), and/or other technology that may implement wireless power transfer to a vehicle while the vehicle is in motion. For example, such transferred power may be used to charge a battery.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices. While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless power necessarily includes a number of components for analog and digital purposes (e.g., hardware components including antenna, power amplifiers, buffers, processor(s), etc.). It is intended that innovations described herein may be practiced in a wide variety of devices, components, and systems, etc. of varying sizes, shapes, and constitutions.

Described herein are the static and dynamic analysis of wireless power transfer for battery-electric locomotives (or any type of battery-electric vehicle), including the design of a multi-transmitter single-receiver (MTSR) wireless power transfer (WPT) system and the calculation of coupling coefficient and output (voltage, current, power) during dynamic charging. In some examples herein, the term “dynamic charging” may refer to charging while an element receiving power is traveling (e.g., is in active motion) over one or more elements transmitting power.

Also described is a MTSR WPT system that utilizes a parallel synchronous multi-LCL-s compensation topology and a W-I shaped coupler. Static testing of a prototype demonstrated a direct current to direct current (DC-DC) efficiency of over 92% with input voltage ranging from 200 to 500 V and output load from 15.5 to 34Ω. At an input power of 3.1 kW, voltage of 705V, and load resistance of 21Ω, the system achieves a maximum efficiency of 94.73%.

Dynamic testing of the MTSR WPT system demonstrated that with an input power of 3 KW, voltage of 500V, and load resistance of 15Ω, the highest dynamic efficiency reached around 89% and remained stable at that level.

An LCL-s compensation topology is described. Such a topology is used to enhance power transfer capability and reduce volt-amps rating in a loosely coupled WPT system. A dynamic WPT system and its components and operation are described, as well as the stages of the dynamic charging process and the corresponding coupling coefficients. A calculation of the output voltage for a three-transmitter and single-receiver WPT system is discussed.

The LCL-s compensation topology is suitable for wireless charging applications based on efficiency, voltage, and current stress. The topology may enhance power transfer capability and reduce volt-amps rating in a loosely coupled WPT system. The dynamic WPT system includes one or more transmitters (Txs) and a receiver (Rx), with multiple transmitters connected to the same DC source. The Rx side may use a silicon carbide (SiC) diode full bridge module to rectify alternating current (AC) back to DC, which is then filtered and sent to the load resistor. The W-I shaped coupler may have I-shaped cores on the Rx side and W-shaped cores on the Tx side. The dynamic charging process may be divided into six stages (by way of example and not limitation). The six exemplary and non-limiting stages may include an approaching stage, a falling stage, a plain stage, a rising stage, a repeated stage, and a leaving stage. The coupling coefficients related to misalignment (kₘᵢₛ) during dynamic charging may vary depending on the alignment of the Rx and the Txs. The output voltage (Vdc_out) can be calculated using the coupling coefficients and other parameters listed in Table I, for example.

Wireless power transfer (WPT), particularly inductive power transfer (IPT), has been extensively researched in the electric vehicle (EV) domain due to its ability to enable automatic charging without manual intervention and its potential for charging while in motion. However, its implementation in battery-electric locomotives has not garnered sufficient attention, especially concerning the dynamic aspect. Described herein may be a multi-transmitter single-receiver (MTSR) WPT system tailored for railway applications, employing a parallel synchronous multi-LCL-s compensation topology and a W-I shaped coupler. The dynamic charging process of this system is analyzed, and methods for calculating the coupling coefficient and output during dynamic charging are derived. A prototype with one receiver and three transmitters was constructed. Static testing utilizing a single-transmitter and single-receiver (STSR) setup revealed that the system maintained a DC-DC efficiency of over 92% with an input DC voltage ranging from 200 to 500 V and an output load from 15.5 to 34Ω. Notably, at an input power of 3.1 kW, voltage of 705V, and load resistance of 21Ω, the system achieved a maximum efficiency of 94.73%. Dynamic testing results demonstrated that with an input power of 3 kW, voltage of 500V, and load resistance of 15Ω, the highest dynamic efficiency reached around 89% and remained stable at this level. Furthermore, the testing results validated the consistency between the system's output characteristics and the calculated results, thereby verifying the rationale of the calculation methods.

The various concepts presented throughout this disclosure may be implemented across a broad variety of systems, networks, architectures, and standards. Wireless power transfer (WPT) technology has attracted considerable attention for its potential to eliminate the need for physical connectors to charge electronic devices and power supplies. Within this context, magnetic materials, including ferrite materials, have emerged as crucial components, primarily attributed to their high magnetic permeability in guiding and concentrating magnetic field lines. Multiple studies have highlighted the advantages of integrating ferrite materials into WPT systems, resulting in improvements in the coupling coefficient, thus enhancing transmission efficiency and overall system performance in connection with, for example, and without limitation, mobile devices, electric vehicles (EVs), and railway applications. Supporting structures associated with the WPT systems may be designed to ensure persistent and repeated performances of the WPT system. A hanging structure described herein, for example, may be hardened to ensure the receiver can maintain a constant airgap between it and each transmitter as the receiver passes, in series, over the multiple transmitters. According to some aspects, a perfectly constant airgap may not be achieved; however, minimizing changes to the magnitude of the airgap (which in practice may be a dynamic variable) provides multiple benefits including, for example, improved system efficiency and improved power transfer. Similarly, the transmitters may be designed to endure ground vibrations due to train movements and other mechanical disturbances. Several of the parts described herein may be additively constructed to minimize material waste and to optimize the strength of the parts described herein, and other parts that may provide utility to the examples described herein.

Electric locomotives are highly efficient, energy-saving, and widely used worldwide. Nonetheless, many low-efficiency and highly polluting fossil-fueled locomotives still operate on railways. For instance, the United States has the world's most extensive railway network, but only 1% of the locomotives have been electrified. Electrifying railways is crucial for environmental protection, yet the high cost presents a considerable challenge. An alternative approach involves retrofitting locomotives with batteries and chargers. The batteries are charged using cables when the vehicle is stationary. However, wired charging is often hindered by the complexity of the process and weather limitations. Moreover, wired charging involves heavy high-voltage cables, which pose labor-intensive work and risk electric shock.

To address the challenges, WPT has been introduced for charging battery-electric locomotives, offering distinct advantages by eliminating the lateral misalignment issue that can affect WPT applications in other fields. Of course, lateral misalignment is eliminated as the distance between the rails on which the battery-electric locomotives travel is highly controlled and standardized. The precise location of the Txs between the rails and atop the railroad ties is readily achievable. Similarly, the precise location of the Rx between the wheels of, and below the body of, a locomotive is also readily achievable. Accordingly, lateral misalignment may be eliminated. This leaves longitudinal misalignment, which is a dynamic variable while the battery-electric locomotive is traveling along the tracks, and the Rx below the locomotive advances toward, travels over, and recedes from any given Tx between the rails and atop the railroad ties.

By enabling charging during parking or even while in motion, WPT reduces parking charging time, reduces the size of battery packs, and enhances cost-effectiveness and usability. In one example, a WPT system for use with a railway with an inductor-capacitor-inductor-series (LCL-s) compensation topology and a letter “W” and letter “I” (W-I) shaped coupler was developed. The W-I-shaped coupler was found to use less magnetic material than other configurations. The LCL-s compensation topology W-I shaped coupler was initially validated at 1.7 kW with a static DC-DC efficiency of 85.6% and then improved to a 5 kW design with a DC-DC efficiency of 92.5%. However, these power levels and efficiency were limited to use of the coupler in static charging only. There remains a gap in the literature regarding the dynamic analysis of WPT technology for battery-electric locomotive applications.

Described herein are theoretical performances substantiated with actual test results, which may address the research gap. A comprehensive dynamic analysis of a WPT system with an MTSR model utilizing a parallel synchronous multi-LCL-s compensation topology and a W-I shaped coupler for battery-electric locomotives is presented.

### Dynamic LCL-s Compensation Topology and W-I Shaped Coupler

The inductor-capacitor-inductor-series (LCL-s) compensation topology is suitable for wireless charging applications based on efficiency, voltage, and current stress. The LCL-s compensation topology may be employed to enhance a power transfer capability and reduce the volt-amps rating on both the source and load sides in a loosely coupled WPT system.

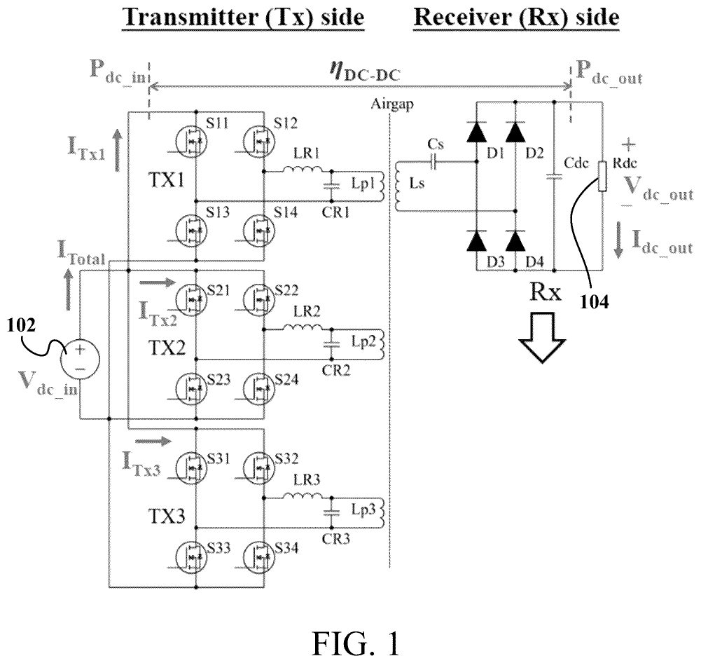

FIG. 1 is an electrical schematic of a WPT system utilizing a dynamic LCL-s compensation topology according to some aspects of the disclosure. The WPT system includes the transmitter (Tx) and the receiver (Rx) 104. For the Tx 102, there are three transmitters (Tx1, Tx2, and Tx3) with a half LCL-s compensation topology coupled to the same DC source (Vdc) in parallel. Four MOSFETs (Sx1, Sx2, Sx3, and Sx4, where “x” is the “identification number” of a given transmitter) were used to generate an 85 kHz AC waveform. All three transmitters (Tx1, Tx2, and Tx3) use the same set of gate drive signals (not shown). Therefore, the three transmitters (Tx1, Tx2, and Tx3) may generate AC and magnetic fields synchronously (e.g., simultaneously or in phase with each other). For the Rx side, a silicon carbide (SiC) diode full bridge module (D1, D2, D3, D4) is used to rectify the AC back to DC, then the DC is filtered by a capacitor Cdc and sent to the load resistor Rdc. Of course, these configurations and examples are for explanation and not limitation.

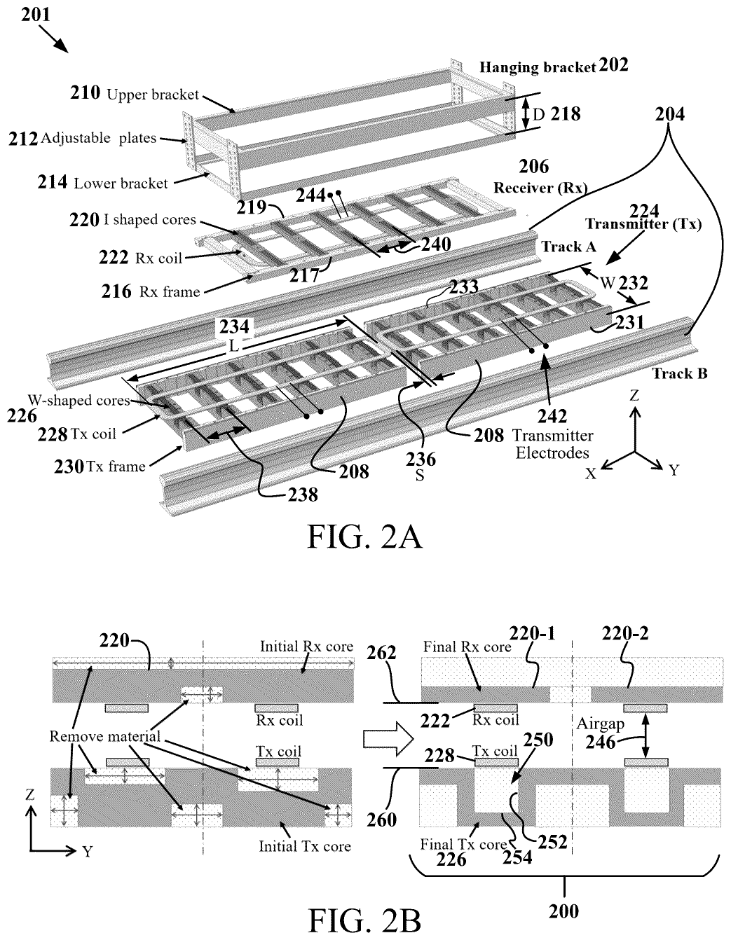

FIG. 2A is a 3D rendering of a W-I shaped coupler 200 (receiver and transmitters) with hanging bracket 202 and tracks 204 (Track A and Track B) according to some aspects of the disclosure. The vertical arrangement from top to bottom is hanging bracket 202, receiver 206, multiple transmitters 208, and tracks 204. In the example of FIG. 2A, the hanging bracket 202 may be a frame structure that includes multiple components, such as the upper bracket 210 at the top, adjustable plates 212 in the middle, and the lower bracket 214 at the bottom. All words expressing relative vertical position (e.g., top, middle, bottom) are expressed relative to the Z-axis in FIG. 2A. The upper bracket 210 may be coupled to a vehicle body (not shown), while the lower bracket 214 may be coupled to a receiver (Rx) frame 216 of the receiver 206. In one example, the lower bracket 214 may be coupled to the receiver (Rx) frame 216 by bolts. In other examples the lower bracket 214 may be coupled to the receiver (Rx) frame 216 by welding. These examples are non-limiting. Other ways to couple the lower bracket 214 to the receiver (Rx) frame 216 are within the scope of the disclosure. A distance (D) 218 between the upper bracket 210 and the lower bracket 214 may be adjustable via, for example, the adjustable plates 212. Other ways to make the distance (D) 218 adjustable are within the scope of the disclosure.

According to some aspects, all structural, connecting, and supporting features, including, but not limited to the hanging bracket 202 and the Rx frame 216, may be made of non-magnetic materials, such as aluminum or aluminum alloys. The receiver 206 includes with multiple pairs of I-shaped cores 220, an Rx coil 222 (also referred to herein as a second coil 222), and the Rx frame 216. Each of the I-shaped cores 220 could be one unit or could be divided into several sub-units or sections. For example, in FIG. 2A and FIG. 2B left side, the I-shaped cores 220 are each one unit. In FIG. 2B right side, after removal of material from the top and the center of the “Initial Rx core” (relative to the Z- and Y-axis, respectively), the “Final Rx core” is thinner and divided into two sections 220-1 and 220-2. Accordingly, each of the I-shaped cores 220 may be one magnetic piece (as exemplified by ref. no. 220) or a “string” of magnetic pieces (as exemplified by ref. nos. 220-1 and 220-2). It is also noted that in some examples, such as in receiver 206 of FIG. 2A, the I-shaped cores may also include grooves (not shown in FIG. 2B, but similar to a groove 250 described below with reference to the W-shaped cores 226) (referred to herein as a receiver groove). Each receiver groove may be defined by receiver groove sidewalls and a receiver groove floor (not shown, but similar to groove sidewalls 252 and groove floor 254 described below with respect to each W-shaped ferromagnetic core 226). In such examples, the receiver groove (visible in FIG. 2A, not shown in FIG. 2B) in the I-shaped cores 220 may be formed adjacent to the second coil 222, on a first side of the second plane 262 opposite to the second coil 222 and the second coil 222 may occupy a location adjacent to and outside of the receiver groove (not shown in FIG. 2B) on a second side of the second plane 262 opposite to the receiver groove. Alternatively, the second coil 222 may be completely or partially located inside the receiver groove, and a width of the second coil 222 may be less than a width of the receiver groove. As used herein, the term “coil” (e.g., Tx coil 228, first coil 228, Rx coil 222, second coil 222) may be used to refer to overlapping loops of wire that may be formed in any shape including, for example, circular, oval, rectangular, rectangular with rounded corners (as shown in FIGS. 2A and 2B), etc. In general, the shape of the Tx coil 228 and the shape of the Rx coil 222 may be the same or similar. For example, the number of turns of wire forming the Tx coil 228 and the Rx coil 222 may be the same or different.

A groove filler (not shown), having a shape that conforms to the sidewalls (and floor) of a groove (either or both of a receiver groove or a transmitter groove), may be fabricated. For example, the groove filler may be printed with a 3D printer. The material used to fabricate the groove filler may be any material with a permeability of 1 (i.e., the permeability of air) or close to 1. In some examples, the groove filler may be 3D printed using a plastic. In some examples, the groove filler may be a polyester or a thermoplastic monomer, such as, for example, polylactic acid (PLA). In some examples, the groove filler may be a paste or other semisolid material that may be spread into the groove and allowed to cure in the groove.

Each transmitter 224 includes multiple W-shaped cores 226, a Tx coil 228 (also referred to herein as a first coil 228), and a Tx frame 230. The transmitter 224 may be positioned between the tracks 204 (between Track A and Track B). The transmitter 224 width (W) 232 may be 30% to 60% of the track gauge (distance between the two rails), or in some examples 35% to 50%, or in some examples may be between about 40% to 45%. In one example, the transmitter 224 width (W) may be about 42.5% of the track gauge. For example, if the track gauge is about 56.5 inches, the transmitter width 232 is about 24 inches. The length of the transmitter, i.e., the Tx coil length (L) 234, may range from about 48 inches to about 144 inches. In some examples the Tx coil length (L) 234 is about 55 inches. The spacing(S) 236 between two transmitters 224 may range from 0 inches to about 48 inches. Improved performance may be obtained with reduced spacing. In one example, the spacing(S) 236 was 0 inches. In the case of a zero inch separation (and other separations), the wire used to form the coils may be insulated wire. One example of insulated wiring is LITZ wire, which has its own insulation coating. Due to the insulation coating, the wires of the coil itself do not short together and the wires of neighboring coils (even neighboring coils with spacing(S) 236 of zero inches, do not short together. Of course, depending on mechanical and electrical aspects of a particular example, thicker insulation (compared to the thin insulation on LITZ wire) may be desired. In such examples, wire with thicker insulation may be used and/or another layer of insulation material, such as heat shrink tubing, electrical tape, or Kapton® tape (an example of a polyimide film tape), may be added. The receiver 206 may have the same width and length as the transmitter 224; however, other widths and lengths are within the scope of the disclosure.

The vertical distance (air gap) 236 (FIG. 2B) between the Tx coil 228 and Rx coil 222 may range from about 2 inches to about 20 inches, or more particularly from about 2 inches to about 8 inches, or in some examples about 5 inches. The top surface of the Tx coil 228 may be about 0 to 4 inches lower than the track surface. Improved performance may be observed as the distance decreases. In one example, the top surface of the Tx coil 228 was about 0 inches from the track surface.

The spacing between the W-shaped cores (W-Shaped Core Spacing 238) of the transmitter 224 ranges from about 0 inches to about 48 inches, or more particularly from about 1 to 12 inches. In one example, the W-Shaped Core Spacing 238 was 6 inches. The spacing between the I-shaped cores (I-Shaped Core Spacing 240) of the receiver 206 may be the same as that between the W-shaped cores of the transmitter; however, other spacings are within the scope of the disclosure.

FIG. 2B is a graphic of the shapes of a transmitter (Tx) side W-shaped core and a receiver (Rx) side I-shaped core including additively constructed (shown as removed) features that can further reduce the weight of the receivers and transmitters fabricated according to some aspects of the disclosure. Specifically, multiple grooves may be formed on the initial core to remove material, and the shape of the core may be adjusted by varying the dimensions (x, y, and z directions) of these grooves. The W-shaped core can be of any transitional shape between a W-shape and a rectangle, preferably W-shaped. The I-shaped core can be of any transitional shape between an I-shape and a rectangle, preferably I-shaped.

According to one example, an apparatus 201 may include one or more transmitters 224, each transmitter 224 including: a transmitter frame 230 including a pair of spaced apart transmitter frame members 231, 233; a plurality of spaced apart W-shaped ferromagnetic cores 226, each of the spaced apart W-shaped ferromagnetic cores 226 located between the pair of spaced apart transmitter frame members 231, 233 and mechanically coupled to the pair of spaced apart transmitter frame members 231, 233; a first length of conductive metal arranged in a first coil 228 on a first plane 260 on the spaced apart W-shaped ferromagnetic cores 226, the first coil 228 having a pair of transmitter electrodes 242. The apparatus 201 may also include a receiver 206, the receiver 206 including: a receiver frame 216 including a pair of spaced apart receiver frame members 217, 219, a plurality of spaced apart I-shaped ferromagnetic cores 220, each of the spaced apart I-shaped ferromagnetic cores 220 located between the pair of spaced apart receiver frame members 217, 219 and mechanically coupled to the pair of spaced apart receiver frame members 217, 219; a second length of conductive metal arranged in a second coil 222 on a second plane 262 on the spaced apart I-shaped ferromagnetic cores 220, the second coil 222 having a pair of receiver electrodes 244.

According to one aspect, the receiver 206 may be configured to slidingly translate along a longitudinal axis (for example, the X-axis) shared with the transmitter 224, in a spaced apart configuration in which the first plane 260 of the transmitter may be separated from the second plane 262 of the receiver by a distance corresponding to an airgap 246.

According to one aspect the transmitter electrodes 242 may be coupled to a source of electrical power (not shown, similar to 102, FIG. 1) and the receiver electrodes 244 may be coupled to an electrical load (not shown, similar to 104, FIG. 1), and/or, for example, an electrical energy storage device (not shown).

According to one aspect, a groove 250 defined by groove sidewalls 252 and a groove floor 254 in each W-shaped ferromagnetic core 226 may be formed adjacent to the first coil 228, on a first side of the first plane 260 opposite to the first coil 228 and the first coil 228 may occupy a location adjacent to and outside of the groove 250 on a second side of the first plane 260 opposite to the groove 250. Alternatively, the first coil 228 may be completely or partially located inside the groove 250, and a width of the first coil 228 may be less than a width of the groove 250.

According to one aspect, the second coil 222 may occupy a location on the second plane 262 opposite to the I-shaped ferromagnetic core 220.

### Coupling Coefficient During Dynamic Charging

For WPT systems used in a dynamic manner in railway systems (e.g., where the word “dynamic” indicates the locomotive in motion), multiple Txs may be used, one after the other, on a common first plane, along a common first linear axis, such that the overall length of the multiple Txs is sufficient to wirelessly transmit a predetermined amount of power (with the locomotive traveling at a predetermined speed) to the Rx under the locomotive (in a second plane that is parallel to and spaced apart from the first plane by the air gap distance) and traveling on a second linear axis (parallel and spaced apart from the first linear axis) under the locomotive. In other words, the number of Txs should be sufficient to cover enough range (e.g., distance) for dynamic charging. Hence, a model with one receiver (Rx) and N transmitters (Tx1 to TxN) is used to analyze the dynamic coupling coefficient.

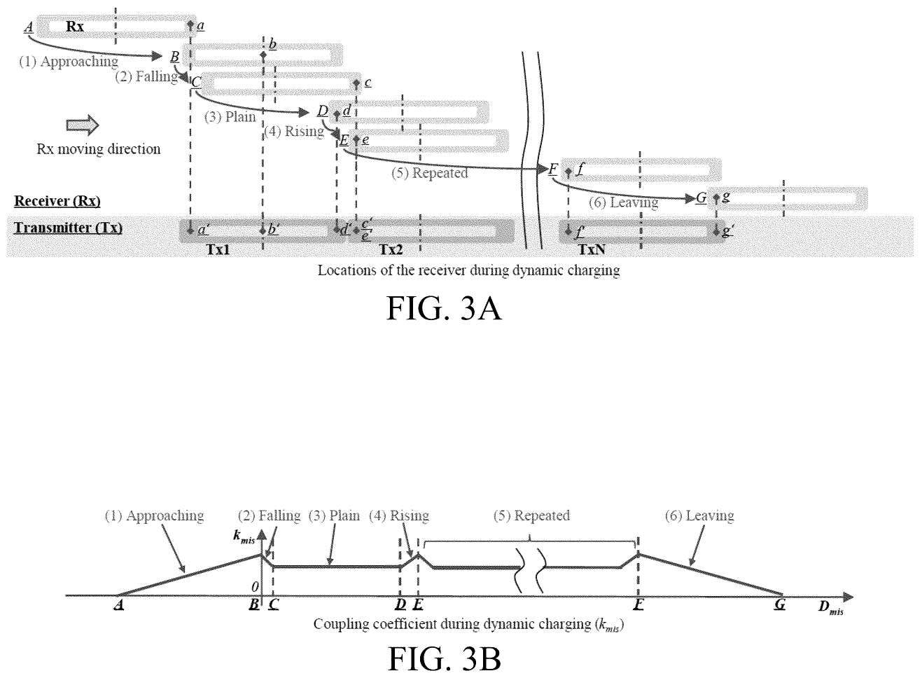

FIG. 3A is a graphic illustration of the locations of a receiver of the WPT system utilizing the dynamic LCL-s compensation topology of FIG. 1 during a dynamic charging process according to some aspects of the disclosure. FIG. 3B is a chart depicting a coupling coefficient (kₘᵢₛ) of the W-I shaped coupler of the WPT system of FIG. 1 and FIG. 2 during dynamic charging according to some aspects of the disclosure. In FIG. 3B, the coupling coefficient is illustrated on the vertical axis, and time is illustrated on the horizontal axis. Together, FIGS. 3A and 3B illustrate key locations and stages of a dynamic charging process at various locations in space and time relative to the position of the Rx with a given Tx in a railway configuration according to some aspects of the disclosure. In a charging process, for exemplary and non-limiting purposes, seven key locations (marked as “A” to “G”) that demarcate six stages are illustrated in FIGS. 3A and 3B. The six stages are described below.

(1) Approaching stage: From location A, where the Rx coil width right center (marked “a”) aligns with the Tx1 coil width left center (marked “a′”), to location B, where the Rx coil center (marked “b”) aligns with the Tx1 coil center (marked “b”).

(2) Falling stage: From location B (“b” aligns with “b′”) to location C, where the Rx coil width right center (marked “c”) aligns with the Tx2 coil width left center (marked “c′”).

(3) Plain stage: From location C (“c” aligns with “c′”) to location D, where the Rx coil width left center (marked “d”) aligns with the Tx1 coil width right center (marked “d”).

(4) Rising stage: From location D (“d” aligns with “d”) to location E, where the Rx coil width left center (marked “e”) aligns with the Tx2 coil width left center (marked “e”).

(5) Repeated stage: From location E (“e” aligns with “e′”) to location F, where the Rx coil width left center (marked “f”) aligns with the TxN (last one) coil width left center (marked “f”). This stage repeats the stages from (2) to (4).

6) Leaving stage: From location F (“f” aligns with “f”) to location G where the Rx coil width left center (marked “g”) aligns with the TxN (last one) coil width right center (marked “g”).

FIG. 3B illustrates the coupling coefficients related to misalignment, kₘᵢₛ, during dynamic charging, which is also divided into the six stages described above.

In the approaching stage from A to B, as Rx gets closer to Tx1, the kₘᵢₛ increases until it reaches the peak value, where Rx aligns with Tx1 at B.

In the falling stage from B to C, Rx leaves Tx1 and starts to align with Tx2; the kₘᵢₛ decreases because there is a gap between Tx1 and Tx2 (if the gap is small, the decrease may not be noticeable).

In the plain stage from C to D, Rx aligns with two Txs at the same time, and the kₘᵢₛ stays constant.

In the raising stage from D to E, Rx leaves Tx1 and starts to align with Tx2 only, the kₘᵢₛ again reaches peak value when Rx aligns with Tx2 at E.

In the leaving stage from F to G, Rx leaves the last Tx, and the kₘᵢₛ decreases, until it goes to 0.

Among these locations, B is selected as the reference, and the misalignment distance Dₘᵢₛ for Rx is assumed to be null. Other locations are within the scope of the disclosure.

### Equations for Coupling Coefficient

The parameters and values presented in Table I may be used to evaluate equations for dynamic coupling coefficients, kₘᵢₛ. The expression of misalignment distance Dₘᵢₛ, which in one example is from the Rx coil center (“b”) to the Tx1 coil center (“b”), for each location is derived and is listed in Table II.

In the approaching stage, from A to B, the Rx is on the left-side of the Tx1 and the Dₘᵢₛ is negative. The coupling coefficient kₘᵢₛ may be determined as:

$${k}_{mis} = {k}_{alg} ( 1 + \frac{2 {D}_{mis}}{{L}_{RxC \_ lo} + {L}_{RxC \_ li}} ) \qquad ( 1 )$$

where k_{alg} is the measured coupling coefficient value obtained by aligning the Rx with one transmitter.

TABLE I
MTSR PARAMETERS FOR DYNAMIC CHARGING

| Parameter | Symbol | Value | |
|---|---|---|---|
| Rx coil outer length | L_{RxC}_{_{—}}ₗₒ | 125.73 cm/49.5 in | |
| Rx coil inner length | L_{RxC}_{_{—}}ₗᵢ | 118.11 cm/46.5 in | |
| Tx coil outer length | L_{TxC}_{_{—}}ₗₒ | 124.46 cm/49 in | |
| Tx coil inner length | L_{TxC}_{_{—}}ₗᵢ | 119.38 cm/47 in | |
| Space between Txs | D_{TT} | 0 | |
| Tx capacitor | C_{R} | 48.89 | nF |
| Rx inductor | Lₛ | 175.30 | μH |
| Rx capacitor | Cₛ | 20 | nF |
| Tx inductor | Lₚ, L_{R} | 71.70 | μH |

| | | |
|---|---|---|
| Aligned coupling coefficient | k_{alg} | 0.2327 |

TABLE II
LOCATIONS AND DISTANCES DURING DYNAMIC CHARGING

| Location | Misalignment Distance Dₘᵢₛ |
|---|---|
| A | $- \frac{( {L}_{TxC \_ lo} + {L}_{TxC \_ li} )}{4} - \frac{( {L}_{RxC \_ lo} + {L}_{RxC \_ h} )}{4}$ |
| B | 0 or (n − 1) (L_{TxC}_lo + D_{TT}) |
| C | $( n - 1 ) ( {L}_{TxC \_ lo} + {D}_{TT} ) + {D}_{TT} + \frac{{L}_{TxC \_ lo} + {L}_{TxC \_ li}}{2}$ |
| D | $( n - 1 ) ( {L}_{TxC \_ lo} + {D}_{TT} ) + \frac{{L}_{RxC \_ lo} + {L}_{{RxC}_{li}}}{4} + \frac{{L}_{TxC \_ lo} + {L}_{TxC \_ li}}{4}$ |
| E | $( n - 1 ) ( {L}_{TxC \_ lo} + {D}_{TT} ) + \frac{{L}_{RxC \_ lo} + {L}_{{RxC}_{li}}}{4} +$ $\frac{{L}_{TxC \_ lo} + {L}_{TxC \_ li}}{4} + \frac{{L}_{TxC \_ lo} - {L}_{TxC \_ li}}{4} + {D}_{TT}$ |
| F | $( N - 2 ) ( {L}_{TxC \_ lo} + {D}_{TT} ) + \frac{{L}_{TxC \_ lo} + {L}_{TxC \_ li}}{4} +$ $\frac{{L}_{TxC \_ lo} + {L}_{TxC \_ li}}{4} + \frac{{L}_{TxC \_ lo} - {L}_{TxC \_ li}}{2} + {D}_{TT}$ |
| G | $( N - 2 ) ( {L}_{TxC \_ lo} + {D}_{TT} ) + \frac{{L}_{RxC \_ lo} + {L}_{RxC \_ li}}{4} +$ $\frac{3 ( {L}_{TxC \_ lo} + {L}_{TxC \_ li} )}{4} + \frac{{L}_{TxC \_ lo} - {L}_{TxC \_ li}}{2} + {D}_{TT}$ |

In the falling stage, from B to C, the Rx is over the Txs and Dₘᵢₛ is positive. The value kₘᵢₛ can be determined as:

$${k}_{mis} = {k}_{alg} ( 1 - \frac{2 ( {D}_{mis} - ( n - 1 ) ( {L}_{TxC \_ lo} + {D}_{TT} ) )}{{L}_{RxC \_ lo} + {L}_{RxC \_ li}} ) \qquad ( 2 )$$

where n is the order of the transmitter, and n∈{1, 2, . . . , N−1}, N is the total number of transmitters (e.g., transmitter sections, transmitter elements).

In the plain stage, from C to D, the Rx is over the Txs and Dₘᵢₛ is positive. The value kₘᵢₛ is a constant value and may be determined as:

$${k}_{mis} = {k}_{alg} ( 1 - \frac{2 ( {D}_{TT} + {L}_{TxC \_ lo} - {L}_{TxC \_ li} )}{{L}_{RxC \_ lo} + {L}_{RxC \_ li}} ) \qquad ( 3 )$$

In the plain stage, from D to E, the Rx is over the Tx and Dₘᵢₛ is positive. The value kₘᵢₛ may be determined as:

$${k}_{mis} = {k}_{alg} ( 1 + \frac{2 ( {D}_{mis} - ( n - 1 ) ( {L}_{TxC \_ lo} + {D}_{TT} ) )}{{L}_{RxC \_ lo} + {L}_{RxC \_ li}} ) \qquad ( 4 )$$

From E to F, the kₘᵢₛ repeats the stage from B to E periodically.

In the falling stage, from F to G, the Rx is over the last TxN, and Dₘᵢₛ is positive. The value kₘᵢₛ may be determined as:

$${k}_{mis} = {k}_{alg} ( 1 - \frac{2 ( {D}_{mis} - ( N - 1 ) ( {L}_{TxC \_ lo} + {D}_{TT} ) )}{{L}_{RxC \_ lo} + {L}_{RxC \_ li}} ) \qquad ( 5 )$$

V_{dc_out} may be calculated as:

$${V}_{dc \_ out} = {k}_{mis} {V}_{dc \_ in} {ω}^{2} \sqrt{{L}_{p} {L}_{s} {C}_{R}} \qquad ( 6 )$$

where Lp, Ls, and C_{R} are listed in Table I.

Then, by combining Eq. (1) to Eq. (6) and setting N=3, for a three-transmitter and single-receiver (TTSR) WPT system with the parameters listed in Table I, the output voltage can be determined as:

$${V}_{dc \_ out} = \{ \begin{matrix}0.3639 ( 1 + \frac{{D}_{mis}}{121.92} ) {V}_{dc \_ in} , & - 121.92 < {D}_{mis} \leq 0 \\ 0.3639 ( 1 - \frac{{D}_{mis}}{121.92} ) {V}_{dc \_ in} , & 0 < {D}_{mis} \leq 2.54 \\ 0.3562 {V}_{dc \_ in} , & 2.54 < {D}_{mis} \leq 121.92 \\ 0.3639 ( 1 + \frac{{D}_{mis} - 124.46}{121.92} ) {V}_{dc \_ in} , & 121.92 < {D}_{mis} \leq 124.46 \\ 0.3639 ( 1 - \frac{{D}_{mis} - 124.46}{121.92} ) {V}_{dc \_ in} , & 124.46 < {D}_{mis} \leq 127 \\ 0.3562 {V}_{dc \_ in} , & 127 < {D}_{mis} \leq 246.38 \\ 0.3639 ( 1 + \frac{{D}_{mis} - 248.92}{121.92} ) {V}_{dc \_ in} , & 246.38 < {D}_{mis} \leq 248.92 \\ 0.3639 ( 1 - \frac{{D}_{mis} - 248.92}{121.92} ) {V}_{dc \_ in} , & 248.92 < {D}_{mis} \leq 370.84\end{matrix} \qquad ( 7 )$$

where Dₘᵢₛ (unit in cm) is the misalignment distance between the centers of the Rx and the Tx1.

Similarly, by setting N=1, these equations can be simplified to Eqn. (8) which may be used to determine the output for the STSR model.

$${V}_{dc \_ out} = \{ \begin{matrix}0.3639 ( 1 + \frac{{D}_{mis}}{121.92} ) {V}_{dc \_ in} , & - 121.92 < {D}_{mis} \leq 0 \\ 0.3639 ( 1 - \frac{{D}_{mis}}{121.92} ) {V}_{dc \_ in} , & 0 < {D}_{mis} \leq 121.92\end{matrix} \qquad ( 8 )$$

### Prototype and Parameters

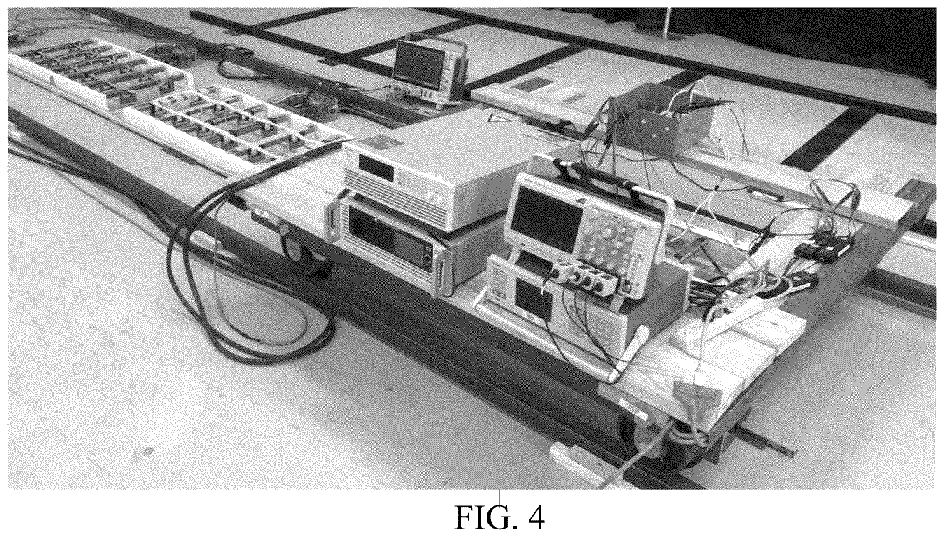

FIG. 4 is a photograph of a physical prototype of the dynamic WPT system of FIG. 1 and FIG. 2 according to some aspects of the disclosure. FIG. 4 shows a movable platform, and two tracks. The three Txs are placed between tracks. The movable platform has four wheels, a steel frame, and a wood panel, and carries the Rx and other test equipment. The Rx is suspended under the movable platform. The track distance is 143.5 cm (56.5 in). A DC source (Chroma 62100H-1000) powers the system, and the electronic load (Chroma 63200A) serves as a load. A power analyzer (Tektronix PA3000) checks the efficiency, and two oscilloscopes monitor the waveforms. The designed and measured parameters are listed in Table III.

TABLE III
PARAMETERS FOR PROTOTYPE

| Component | Symbol | Designed | Measured |
|---|---|---|---|
| Tx coil (μH) | Lₚ₁ | 71.70 | 72.64 |
| | Lₚ₂ | | 71.63 |
| | Lₚ₃ | | 71.71 |
| Tx Inductor (μH) | L_{R1} | 71.70 | 72.64 |
| | L_{R2} | | 71.63 |
| | L_{R3} | | 71.71 |
| Tx Capacitor (nF) | C_{R1} | 48.89 | 48.26 |
| | C_{R2} | | 48.94 |
| | C_{R3} | | 48.90 |
| Rx inductor (nF) | Lₛ | 175.30 | 176.43 |
| Rx Capacitor (nF) | Cₛ | 20 | 20 |
| DC Capacitor (nF) | C_{dc} | 120 | 120 |
| Load resistor (Ω) | R_{dc} | 5-50 | 5-50 |
| Air Gap (cm) | D_{A} | 12.7 | 12.7 |
| Frequency (Hz) | f | 85k | 85k |

### Static Analysis

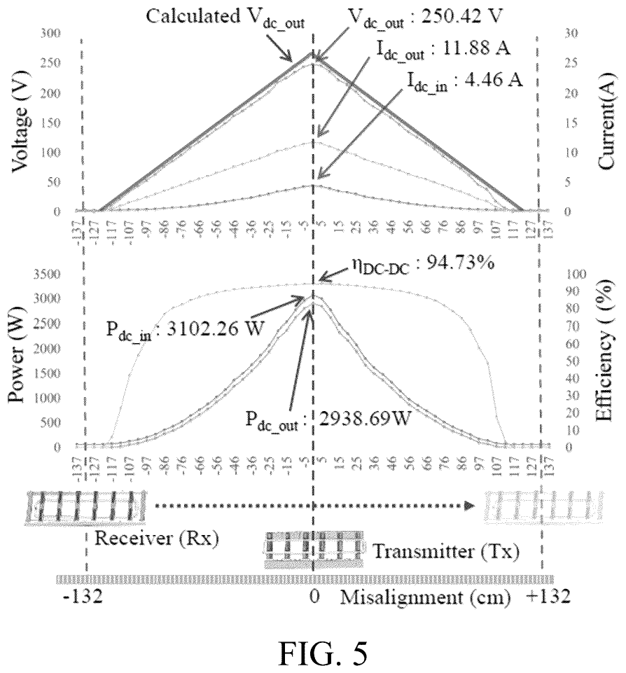

FIG. 5 presents multiple charts and a pictograph depicting a single-transmitter single-receiver (STSR) misalignment model experimental setup and results according to some aspects of the disclosure. In FIG. 5, in an upper chart, voltage (in units of Volts) is represented on the left-side vertical axis and current (in units of Amps) is represented on the right-side vertical axis. Also in FIG. 5, in a lower chart, power (in units of Watts) is represented on the left-side vertical axis and efficiency (unitless) is represented on the right-side vertical axis. Still further in FIG. 5, in a pictograph at the bottom of the figure, an Rx is depicted as traveling from left to right. The horizontal axis of both the upper chart and the lower chart depicts the longitudinal misalignment (in units of cm) of the Rx relative to the Tx, as depicted in the pictograph at the bottom of the figure. The misalignment performance is evaluated using the STSR model with only one Tx powered on. The input power V_{dc_in} is 705 V, and the load resistance Rdc is set to 21Ω. The results are depicted in FIG. 5, in which the bottom part illustrates the positions of Tx and Rx. The Rx moves horizontally above Tx from left to right, covering a range of −132 to +132 cm of misalignment, where misalignment refers to the distance between the centers of Rx and Tx.

The top part of FIG. 5 displays the output voltage V_{dc_out}, input current I_{dc_in}, output current I_{dc_out}, and the calculated output voltage V_{dc_out}. The V_{dc_out} and I_{dc_out} waveforms resemble triangles. This suggests that the coupling coefficient or mutual inductance is linearly related to misalignment. Meanwhile, the input current exhibits a parabolic shape, resulting from the constant input voltage and constant resistance load. The results show the maximum V_{dc_out} of 250.42 V, the maximum I_{dc_out} of 11.88 A, and the maximum I_{dc_in} of 4.46 A during test. Furthermore, the calculated V_{dc_out} (peak value is 256.5 V) is consistent with the experimental waveforms, verifying the correctness of the method. However, it should be pointed out that there is a spike in the calculated waveform, but it is not apparent in the experimental waveform. This is mainly due to the difference in coil size between the computational model and the experimental setup.

The middle part of FIG. 5 presents the input power P_{dc_in}, output power P_{dc_out}, and DC-DC efficiency η_{DC-DC} versus misalignment. The results indicate that η_{DC-DC} reaches a maximum value of 94.73% when the receiver aligns with the transmitter, corresponding to the maximum P_{dc_in} of 3102.26 W and the maximum P_{dc_out} of 2938.69 W. Furthermore, the efficiency curve demonstrates that the system maintains a high efficiency of 90% even when the misalignment is 40 cm, which is approximately ⅓ of the total length of the transmitter coil. This highlights the excellent anti-misalignment performance of the system.

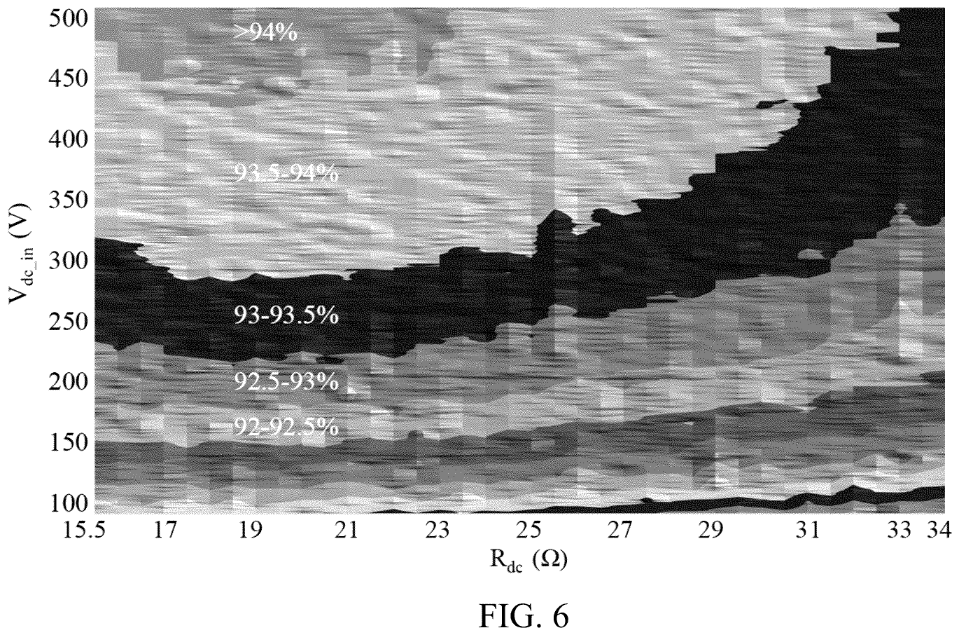

FIG. 6 is an efficiency map presenting zones of efficiency for various values of input voltage and load resistance according to some aspects of the disclosure. In FIG. 6, input DC voltage (in Volts) is represented along the vertical axis, and load resistance (in Ohms) is represented along the horizontal axis. An efficiency map is drawn and shown in FIG. 6, where different colors indicate different efficiency levels. It is evident that within the test ranges, the system tends to achieve high efficiencies, particularly with the load resistor between 15.5 and 23Ω. Additionally, from the perspective of input voltage, the system's efficiency improves with increasing voltage. Moreover, the system can be highly efficient in a wide range of input voltage and load resistors. These test results offer valuable insights and references for the system's future applications.

### Dynamic Analysis

The dynamic tests were executed with a TTSR, whose topology is depicted in FIG. 1. The test setup was as follows: Input power is 3 kW, with an input voltage V_{dc_in} of 500 V and a load resistor Rdc of 15Ω. The space between transmitters DTT is 0 cm. The Rx moves over Tx1, Tx2, and Tx3 from left to right, corresponding to misalignment ranging from −204.5 to +458.5 cm, and the misalignment represents the distance between the centers of Rx and Tx1.

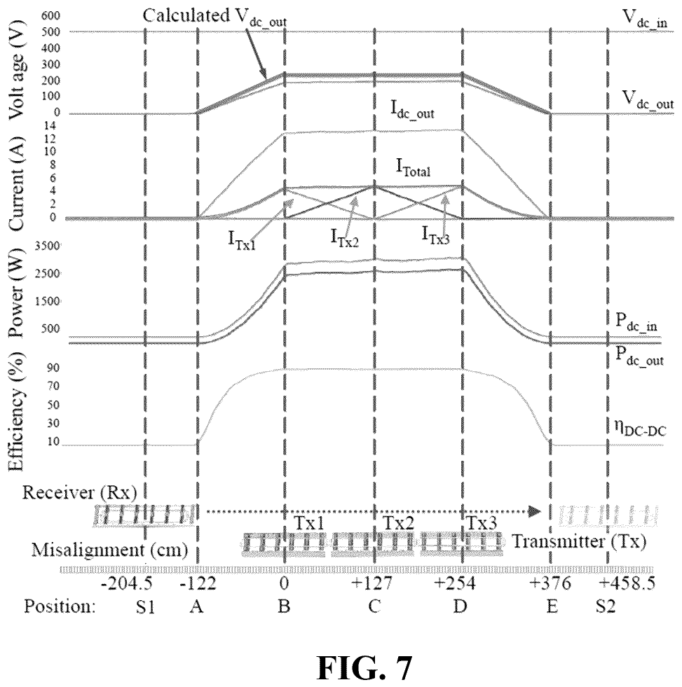

FIG. 7 presents multiple experimental results for a three-transmitter single-receiver (TTSR) WPT system collected from a physical dynamic experimental setup according to some aspects of the disclosure. Of course, any number of transmitters is within the scope of the disclosure. In FIG. 7, DC-DC efficiency (expressed as a percentage), power (in units of Watts), current (in units of Amps), and voltage (in units of Volts) are represented along the vertical axis; longitudinal misalignment of a receiver relative to a transmitter (in units of cm) is represented along the horizontal axis. A plurality of “positions” (S1, A, B, C, D, E, and S2) are identified on the horizontal axis of the graph for convenient points of reference. A pictograph of the receiver (Rx) relative to the position of the transmitter (Tx) is also shown for reference at the bottom of the figure. The Rx moves from left to right. Multiple results are presented for power, current, and voltage. For example, DC-DC efficiency is shown relative to the efficiency portion of the graph of FIG. 7. DC input power (P_{dc_in}) and DC output power (P_{dc_out}) are shown relative to the power portion of the graph of FIG. 7. DC input current (I_{dc_out}), total input current (I_{Total}), input current of Tx1 (I_{Tx1}), input current of Tx2 (I_{Tx2}), and input current of Tx3 (I_{Tx3}) are shown relative to the current portion of the graph of FIG. 7. DC input voltage (V_{dc_in}) and DC output voltage (V_{dc_out}) are shown relative to the voltage portion of the graph of FIG. 7. Some details of the different positions are described below.

(1) At position S1, the Rx is initially located, corresponding to a misalignment of 204.5 cm. At this point, no power is transferred. However, there is still some input power, approximately 230 W, due to circuit losses.

(2) At position A, the Rx coil starts to align with the Tx1 coil, corresponding to a misalignment of −122 cm. A current is induced in the Rx coil, leading to an increase in I_{Tx1}. Consequently, the system begins to produce output voltage, current, and power, and the DC-DC efficiency is no longer zero.

(3) From A to B, the Rx continues approaching the Tx1. During this transition, more of the Rx coil aligns with the Tx1 coil, causing V_{dc_out}, I_{dc_out}, P_{dc_out}, and η_{DC-DC} to increase.

(4) At position B, the Rx coil aligns perfectly with the Tx1 coil, corresponding to 0 cm. I_{Tx1} reaches its peak value, and the Rx coil generates the maximum current. The system operates at its maximum V_{dc_out}, I_{dc_out}, P_{dc_out}, and η_{DC-DC}. Additionally, I_{Tx2} begins to increase as the Rx coil is very close to the Tx2 coil.

(5) From position B to C, the Rx switches from Tx1 to Tx2, and the Rx coil begins to align with both the Tx1 and Tx2 coil simultaneously. With the moving of Rx, I_{Tx1} decreases, I_{Tx2} increases, and Tx2 starts transmitting more energy. It is worth pointing out that the system maintains stable output, maximum power output, and maximum efficiency during the switching.

(6) At position C, the Rx coil aligns perfectly with the Tx2 coil, corresponding to +127 cm. At this point, I_{Tx2} reaches the peak value, I_{Tx1} reduces to almost 0, and I_{Tx3} starts to increase as the Rx coil starts to align with the Tx3 coil. The system's output remains stable, operating at maximum power and efficiency.

(7) From C to E, like the earlier transition from A to C, the system output characteristics follow a symmetric pattern. As the Rx moves away from Tx2, aligns with Tx3, and then leaves Tx3, the input current gradually shifts from Tx2 to Tx3, eventually decreasing to zero. The system's output power and efficiency also decrease from their maximum values to zero.

(8) From E to S2: In this stage, there is no output.

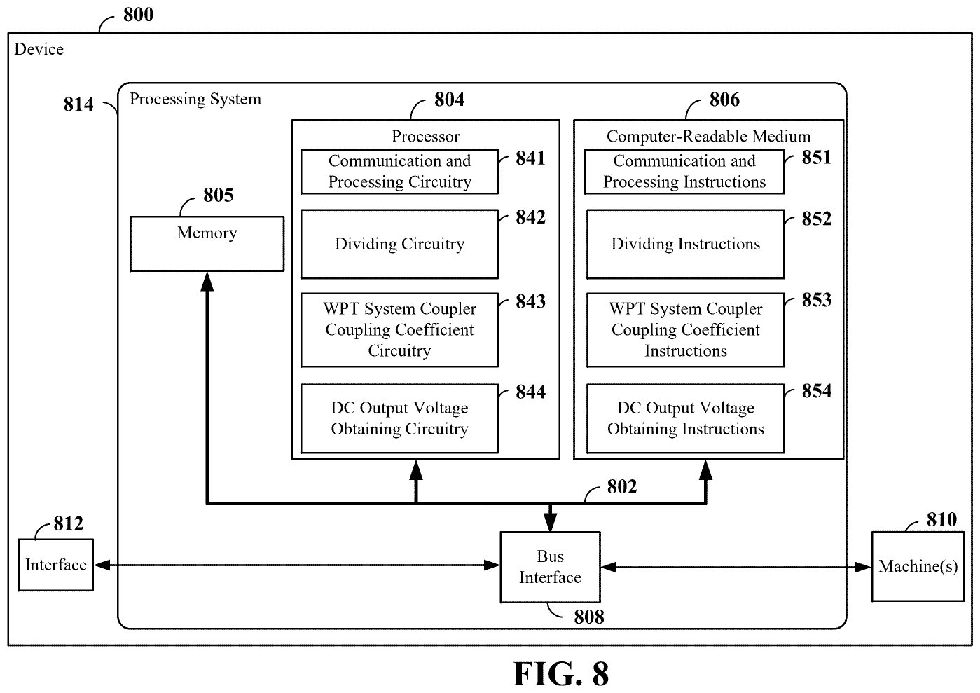

FIG. 8 is a block diagram illustrating an example of a hardware implementation of a device 800 (e.g., an apparatus) employing one or more processing systems (generally represented by processing system 814) according to some aspects of the disclosure. The device 800 may store and execute instructions associated with predicting a direct current output voltage of a wireless power transfer (WPT) system coupler, for example. The device 800 may store and execute instructions that may be used to drive machines (e.g., multi-axis end mills, shapers, presses, mixers, other computer aided manufacturing devices or apparatus), for example.

In accordance with various aspects of the disclosure, an element, any portion of an element, or any combination of elements may be implemented with a processing system 814 that includes one or more processors, generally represented by processor 804, and one or more memories, generally represented by the memory 805 and additionally or alternatively generally represented by the computer-readable medium 806. Examples of processor 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the device 800 may be configured to perform any one or more of the functions described herein. That is, the one or more processors (generally represented by processor 804), as utilized in the device 800, may be configured to, individually or collectively, based at least in part on information stored in the one or more memories (generally represented by the memory 805 and additionally or alternatively generally represented by the computer-readable medium 806), implement (e.g., perform) any one or more of the methods or processes described and illustrated, for example, in FIGS. 1, 2, 3, 4, and/or 5.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits, including one or more processors (generally represented by the processor 804), one or more memories (generally represented by the memory 805), and one or more computer-readable media (generally represented by the computer-readable medium 806). The bus 802 may also link various other circuits such as timing sources, peripherals, voltage regulators, and power management circuits, which are well known to persons having ordinary skill in the art and, therefore, will not be described any further.

A bus interface 808 provides an interface between the bus 802 and one or more machine(s) 810 (e.g., multi-axis end mills, shapers, presses, mixers, other computer aided manufacturing devices or apparatus), for example. The machine(s) 810 may provide a means for manufacturing a WPT system coupler having a coupling coefficient obtained according to, but not limited to, any of the various processes and functions described herein. The bus interface 808 may provide an interface between the bus 802 and a user interface 812 (e.g., keypad, display, touch screen, printer, speaker, microphone, control features, sound, and/or light warning/alert/feedback devices, etc.). Of course, such a user interface 812 is optional and may be omitted in some examples.

One or more processors, represented individually and collectively by processor 804, may be responsible for managing the bus 802 and general processing, including the execution of software stored on the computer-readable medium 806. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 806. The software, when executed by the processor 804, causes the processing system 814 to perform the various processes and functions described herein for any particular apparatus.

The computer-readable medium 806 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing the device 800 (e.g., a computer, one or more processors) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may reside in the processing system 814, external to the processing system 814, or distributed across multiple entities, including the processing system 814. The computer-readable medium 806 may be embodied in a computer program product or article of manufacture. For example, a computer program product or article of manufacture may include a computer-readable medium in packaging materials. In some examples, the computer-readable medium 806 may be part of the memory 805. Persons having ordinary skill in the art will recognize how best to implement the described functionality presented throughout this disclosure depending on the particular application and the overall design constraints imposed on the overall system. The computer-readable medium 806 and/or the memory 805 may also be used for storing data that is manipulated by the processor 804 when executing software.

In some aspects of the disclosure, the processor 804 may include communication and processing circuitry 841 configured for various functions, including, for example, communicating with a user via the user interface 812 and/or the machine(s) 810. In some examples, the communication and processing circuitry 841 may include one or more hardware components that provide the physical structure that performs processes related to communication (e.g., signal reception and/or signal transmission) and signal processing (e.g., processing a received signal and/or processing a signal for transmission). The communication and processing circuitry 841 may further be configured to execute communication and processing instructions 851 (e.g., software) stored, for example, on the computer-readable medium 806 to implement one or more functions described herein.

In some aspects of the disclosure, the processor 804 may include dividing circuitry 842 configured for various functions, including, for example, dividing a predetermined length of a plurality of transmitters into a plurality of longitudinal misalignment distances, each of the plurality of longitudinal misalignment distances associated with a distance between a receiver element of the coupler and a center of the plurality of transmitters. The dividing circuitry 842 may further be configured to execute dividing instructions 852 (e.g., software) stored, for example, on the computer-readable medium 806 to implement one or more functions described herein.

In some aspects of the disclosure, the processor 804 may include WPT system coupler coupling coefficient circuitry 843 configured for various functions, including, for example, obtaining a WPT system coupler coupling coefficient with respect to each of the plurality of longitudinal misalignment distances. The WPT system coupler coupling coefficient circuitry 843 may further be configured to execute WPT system coupler coupling coefficient instructions 853 (e.g., software) stored, for example, on the computer-readable medium 806 to implement one or more functions described herein.

In some aspects of the disclosure, the processor 804 may include DC output voltage obtaining circuitry 844 configured for various functions, including, for example, obtaining a plurality of intermediate direct current output voltages associated with each of the plurality of longitudinal misalignment distances and the respective WPT system coupler coupling coefficients. The DC output voltage obtaining circuitry 844 may additionally or alternatively be configured for various other functions, including, for example, obtaining the direct current output voltage by summing the plurality of intermediate direct current output voltages. The DC output voltage obtaining circuitry 844 may further be configured to execute DC output voltage obtaining instructions 854 (e.g., software) stored, for example, on the computer-readable medium 806 to implement one or more functions described herein.

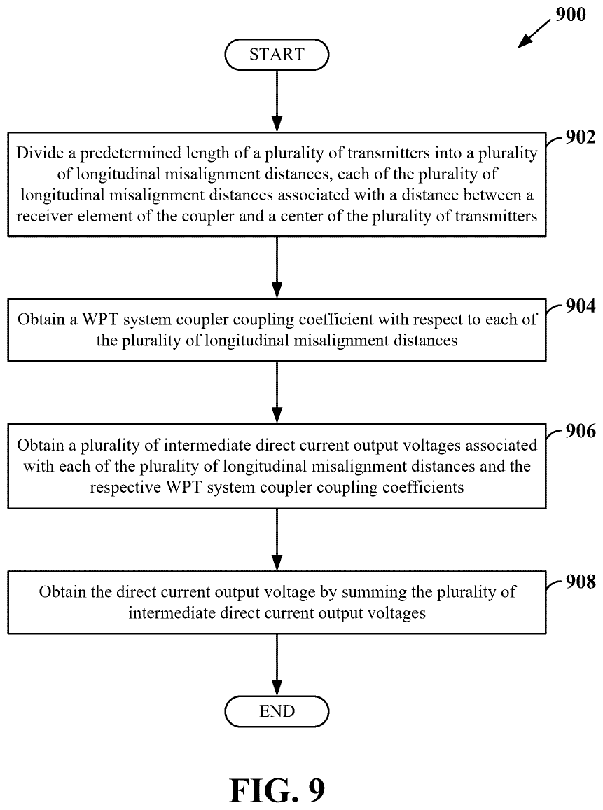

FIG. 9 is a flow chart illustrating an example process 900 (e.g., a method) of predicting a direct current output voltage of a wireless power transfer (WPT) system coupler in accordance with some aspects of the disclosure. The WPT system coupler may be similar to the WPT system coupler as shown and described in FIGS. 1, 2, and/or 4. As described below, some or all illustrated features may be omitted in a particular implementation within the scope of the present disclosure, and some illustrated features may not be required for implementation of all embodiments. In some examples, the process 900 may be carried out by the device 800 of FIG. 8, utilizing a processor 804 of a processing system 814 as shown and described, for example, in connection with FIG. 8. In some examples, various circuits of the device 800 may provide the means to perform the processes described and illustrated, for example, with respect to blocks 902-908 of FIG. 9. In some examples, the process 900 may be carried out by any suitable apparatus or means for carrying out the functions or algorithm described below.

According to some examples, the WPT system coupler may be a W-I shaped WPT system coupler. In some examples, the WPT system coupler may utilize an inductor-capacitor-inductor-series (LCL-s) compensation topology.

At block 902, a processor of a processing system may divide a predetermined length of a plurality of transmitters into a plurality of longitudinal misalignment distances, each of the plurality of longitudinal misalignment distances associated with a distance between a receiver element of the coupler and a center of the plurality of transmitters.

At block 904, the processor may obtain a WPT system coupler coupling coefficient with respect to each of the plurality of longitudinal misalignment distances.

At block 906, the processor may obtain a plurality of intermediate direct current output voltages associated with each of the plurality of longitudinal misalignment distances and the respective WPT system coupler coupling coefficients.

At block 908, the processor may obtain the direct current output voltage by summing the plurality of intermediate direct current output voltages.

The experimental results show that the system's input and output power increase smoothly from zero to their maximum values as the receiver approaches the transmitter. Similarly, as the Rx moves away from the Txs, the input power and output power decrease smoothly back to zero. These characteristics are advantageous for practical applications, as they help mitigate the impact of excessive dv/dt and di/dt on the system and the power grid. Additionally, when the Rx is positioned above the Txs, the system's input and output power are maintained at their maximum values with high stability during the switching process between Txs. Moreover, the system can maintain its highest efficiency during dynamic charging. Finally, similar to the static analysis, the calculated V_{dc_out} are also highly consistent with the experimental waveforms. This verifies the correctness of the calculation method.

Due to the experiment not selecting the maximum efficiency point and accounting for circuit losses between the Txs, the system's maximum efficiency for the dynamic experiments is only approximately 89%, which is less than the highest efficiency of 94.73% for the static case.

Herein has been described a dynamic multiple-transmitter and single-receiver (MTSR) wireless power transfer (WPT) system with an LCL-s compensation topology and a W-I shaped coupler exemplified with a battery-electric locomotive application (but not limited to the battery-electric locomotive application). During static charging, the system achieved a DC-DC efficiency of 94.73% at 2938 W output and acquired efficiencies of more than 92.0% with wide input voltage and load resistance ranges. During dynamic charging, the system maintained the highest efficiency level of around 89%. The equations for calculating the dynamic coupling coefficients have also been analyzed and proved to be consistent with the test result. The designs shown herein may be configured with a control system to enable bidirectionality with the WPT system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A and/or B may include A only, B only, or a combination of A and B.

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples can also be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

### ABSTRACT

Predicting a DC output voltage of a WPT coupler includes dividing a length of transmitters into longitudinal misalignment distances, each associated with a distance between a receiver and a center of the transmitters, obtaining a coupling coefficient for each longitudinal misalignment distance and intermediate DC output voltages associated with each longitudinal misalignment distance and coupling coefficient, and summing the intermediate DC output voltages. An apparatus includes a transmitter frame, spaced apart W-shaped ferromagnetic cores, and a first conductive metal arranged in a first coil on a first plane on the W-shaped ferromagnetic cores. The apparatus includes a receiver frame, spaced apart I-shaped ferromagnetic cores, and a second conductive metal arranged in a second coil on a second plane on the I-shaped ferromagnetic cores. The receiver slidingly translates along a longitudinal axis shared with the transmitter and the first plane is separated from the second plane by an airgap.

What is claimed is:

1. A method of predicting a direct current output voltage of a wireless power transfer (WPT) system coupler, comprising
dividing a predetermined length of a plurality of transmitters into a plurality of longitudinal misalignment distances, each of the plurality of longitudinal misalignment distances associated with a distance between a receiver element of the coupler and a center of the plurality of transmitters;
obtaining a WPT system coupler coupling coefficient with respect to each of the plurality of longitudinal misalignment distances;
obtaining a plurality of intermediate direct current output voltages associated with each of the plurality of longitudinal misalignment distances and the respective WPT system coupler coupling coefficients; and
obtaining the direct current output voltage by summing the plurality of intermediate direct current output voltages.

2. The method of claim 1, wherein the WPT system coupler is a W-I shaped WPT system coupler.

3. The method of claim 1 wherein the WPT system coupler utilizes an inductor-capacitor-inductor-series (LCL-s) compensation topology.

4. An apparatus configured to predict a direct current output voltage of a wireless power transfer (WPT) system coupler, comprising:
one or more memories; and
one or more processors being configured to, individually or collectively, based at least in part on information stored in the one or more memories:
divide a predetermined length of a plurality of transmitters into a plurality of longitudinal misalignment distances, each of the plurality of longitudinal misalignment distances associated with a distance between a receiver element of the coupler and a center of the plurality of transmitters;
obtain a WPT system coupler coupling coefficient with respect to each of the plurality of longitudinal misalignment distances;
obtain a plurality of intermediate direct current output voltages associated with each of the plurality of longitudinal misalignment distances and the respective WPT system coupler coupling coefficients; and
obtain the direct current output voltage by summing the plurality of intermediate direct current output voltages.

5. The apparatus of claim 4, wherein the WPT system coupler is a W-I shaped WPT system coupler.

6. The apparatus of claim 4 wherein the WPT system coupler utilizes an inductor-capacitor-inductor-series (LCL-s) compensation topology.

7. An apparatus comprising:
one or more transmitters, each transmitter including:
a transmitter frame including a pair of spaced apart transmitter frame members,
a plurality of spaced apart W-shaped ferromagnetic cores, each of the plurality of spaced apart W-shaped ferromagnetic cores located between the pair of spaced apart transmitter frame members and mechanically coupled to the pair of spaced apart transmitter frame members, and
a first length of conductive metal arranged in a first coil on a first plane on the plurality of spaced apart W-shaped ferromagnetic cores, the first coil having a pair of transmitter electrodes;
a receiver, the receiver including:
a receiver frame including a pair of spaced apart receiver frame members,
a plurality of spaced apart I-shaped ferromagnetic cores, each of the plurality of spaced apart I-shaped ferromagnetic cores located between the pair of spaced apart receiver frame members and mechanically coupled to the pair of spaced apart receiver frame members, and
a second length of conductive metal arranged in a second coil on a second plane on the plurality of spaced apart I-shaped ferromagnetic cores, the second coil having a pair of receiver electrodes; and
the receiver configured to slidingly translate along a longitudinal axis shared with the transmitter, in a spaced apart configuration in which the first plane of the transmitter is separated from the second plane of the receiver by a distance corresponding to an airgap.

8. The apparatus of claim 7, wherein the pair of transmitter electrodes are coupled to a source of electrical power and the pair of receiver electrodes are coupled to an electrical load.

9. The apparatus of claim 7, wherein a groove defined by groove sidewalls and a groove floor in each of the plurality of W-shaped ferromagnetic cores is formed adjacent to the first coil, on a first side of the first plane opposite to the first coil and the first coil occupies a location adjacent to and outside of the groove on a second side of the first plane opposite to the groove.

10. The apparatus of claim 7, wherein the second coil occupies a location on the second plane opposite to the plurality of I-shaped ferromagnetic cores.
